(19) United States
(12) Patent Application Publication
(10) Pub. No.: US 2026/0116033 A1
(43) Pub. Date: Apr. 30, 2026

(54) METHOD AND MACHINE FOR PRODUCING AN ARTICLE COMPRISING A FOLDED SHEET

(71) Applicant: G.D S.p.A, Bologna (BO) (IT)

(72) Inventors: Fulvio Boldrini, Bologna (BO) (IT); Mirco Legnani, Bologna (BO) (IT); Giuliano Gamberini, Bologna (BO) (IT)

(21) Appl. No.: 18/952,077

(22) Filed: Nov. 19, 2024

(30) Foreign Application Priority Data
Nov. 23, 2023 (IT) 102023000024969

(51) Int. Cl. B31B 50/62; B31B 120/25

(52) U.S. Cl. CPC B31B 50/624; B31B 2120/25

(57) ABSTRACT

Method and machine (1) for producing an article (A) comprising a folded sheet (F), the machine (1) comprising two support elements (4) that are movable and directly consecutive to each other, structured to hold the sheet (F) disposed on them; a first deposition system (11) for arranging the sheet (F) on the two support elements (4); a second deposition system (61) for arranging a base layer(S) in correspondence with the two support elements (4); a gluing material dispensing system (81); and a control unit (10) configured for: arranging the sheet (F) on holding onto the two support elements (4), reciprocally approaching the two support elements (4) for making on the sheet (F) a fold (P), bringing two terminally opposite folding lines (P1a, P1c) of the fold (P) into mutual contact, applying gluing material onto the sheet (F), and coupling the base layer(S) to the sheet (F) for producing the article (A).

### TECHNICAL FIELD OF THE INVENTION

The present invention relates to a method and a machine for producing an article comprising a folded sheet, for example a sheet made of paper or cardboard, polymeric material, or metallic material.

### STATE OF THE ART

In the field of packaging, there is a recognized need to produce articles comprising a sheet, typically made of paper/cardboard or plastic material or metallic material, which is folded, meaning a sheet featuring one or more folds. For example, when it is necessary to securely position a plurality of objects, such as vials, consumable spare parts (e.g., cartridges, brush heads for electric toothbrushes, etc.), inside a larger container, it is known to insert into such containers an article comprising a folded sheet, which, due to its folds, provides housing compartments for the plurality of objects (e.g. one compartment for each object or pair of objects).

### SUMMARY OF THE INVENTION

The term “linear guide” refers to a guide having main development line (i.e., the physical dimension along which the guide primarily extends) that extends in a plane or in the three-dimensional space in any shape, for example by combining straight segments, curved segments, flat segments, ascending segments, descending segments, horizontal segments, vertical segments, etc. Typically, this main development line (in use travelled by support elements in a given direction) defines a processing path.

With reference to the processing path, a first station is considered “upstream” of a second station when the first station precedes the second station, whereas the second station is considered “downstream”of the first station as it follows the first station.

The term “arranging a sheet on holding” refers to securing two or more portions of the sheet onto respective support elements (preferably on all the support elements) to prevent a relative movement between said portions of sheet and said respective support elements at least during the folding process (typically also during the handling of the sheet).

Two elements are considered “directly consecutive” when they are positioned one after the other without the interposition of any further element (of the same nature).

The terms “perpendicular” and “orthogonal” refer respectively to substantial perpendicularity and orthogonality between two elements, comprising both the ideal case in which these elements are provided relative to one another to form a right angle, and more common cases where the two elements are provided relative to one another to form an angle that deviates from the right angle (e.g., within a range of +−15°, more preferably +−10°, from the right angle) but still in a way that is negligible or not significant for the operation of the present solution. Similarly, the term “parallel” and similar terms refer to a condition of pure parallelism or parallelism within the range of 0°+−15°, more preferably +−10°.

In the aforementioned context, the Applicant has faced the problem of producing an article comprising a folded sheet in a simple, quick, and economical manner, while also ensuring the desired quality of the finished article.

According to the Applicant, the above problem is solved by a method and a machine for producing an article in accordance with the attached claims and/or having one or more of the following features.

According to a first aspect, the invention relates to a method for producing an article comprising a folded sheet.

Preferably the method comprises providing a plurality of support elements, preferably mutually movable. Preferably, two directly consecutive support elements of said plurality of support elements are placed at a non-zero mutual initial distance.

Preferably the method comprises arranging a sheet on holding onto said two support elements.

Preferably the method comprises reciprocally approaching said two support elements for making on said sheet a fold. Preferably, said fold comprises at least three folding lines arranged in spatial sequence on said sheet.

Preferably the method comprises bringing two terminally opposite folding lines of said at least three folding lines into substantial mutual contact.

Preferably the method comprises, with said two terminally opposite folding lines into substantial mutual contact, applying a gluing material on said sheet at opposite side to said two support elements.

Preferably the method comprises coupling a base layer to said sheet with said gluing material interposed between said base layer and said sheet, for producing said article. According to another aspect, the invention relates to a machine for producing an article comprising a folded sheet.

Preferably the method comprises a plurality of support elements, preferably mutually movable. Preferably two directly consecutive support elements of said plurality of support elements are structured for holding a sheet when arranged onto said two support elements.

Preferably the machine comprises a first deposition system structured for arranging said sheet onto said two support elements.

Preferably the machine comprises a second deposition system structured for arranging a base layer at said two support elements.

Preferably the machine comprises a dispensing system structured for dispensing a gluing material.

Preferably the machine comprises a control unit.

Preferably the control unit is programmed for commanding said two support elements. Preferably the control unit is programmed for bringing said two support elements at a non-zero mutual initial distance.

Preferably the control unit is programmed for commanding said first deposition system. Preferably the control unit is programmed for arranging said sheet onto said two support elements by means of said first deposition system.

Preferably, the control unit is programmed for holding said sheet by means of said two support elements.

Preferably the control unit is programmed for reciprocally approaching said two support elements for making on said sheet a fold. Preferably said fold comprises at least three folding lines arranged in spatial sequence on said sheet.

Preferably the control unit is programmed for commanding said two support elements for bringing two terminally opposite folding lines of said at least three folding lines into substantial mutual contact.

Preferably the control unit is programmed for commanding said dispensing system. Preferably the control unit is programmed for applying said gluing material by means of said dispensing system onto said sheet at opposite side to said two support elements.

Preferably the control unit is programmed for commanding said second deposition system. Preferably the control unit is programmed for coupling by means of said second deposition system said base layer to said sheet with said gluing material interposed between said base layer and said sheet, for producing said article.

According to the Applicant, the arrangement of the mutually movable support elements allows the sheet to be folded in a simple and rapid manner by the mutual approach of the support elements.

The arrangement of the two terminally opposite folding lines into substantial mutual contact and the application of the gluing material once these terminally opposite folding lines have reached said substantial mutual contact, allow to strongly limit, even entirely avoid, the oozing of the gluing material inside the fold, i.e., in contact with the sheet portions that form the fold, thus preventing soiling of these sheet portions as well as the machine components located near the fold of the sheet (e.g., due to subsequent further leakage of gluing material from the fold). In this way, the application of the gluing material is kept controlled, spatially confining the gluing material only where necessary for the production of the article, to preserve other portions of the sheet and the machine components, thereby reducing waste of non-compliant articles (e.g., due to adhesive applied where not intended) and/or the maintenance work (e.g., cleaning) of the machine. Furthermore, thanks to the said substantial mutual contact of the terminally opposite folding lines, it is possible to ensure a high level of hygiene at the fold, which is particularly advantageous, especially if the article, once in the packaging, is to hold objects related to oral hygiene, such as, for example, replacement brush heads for electric toothbrushes. The application of the base layer and the adhesion to the folded sheet through the gluing material completes the article, providing structural strength and securing the desired folded shape of the sheet.

In this way, it is possible to produce the article in a simple, rapid, cost-effective manner, while achieving the desired qualities, such as the shape and/or technical specifications of the article.

The present invention in one or more of the aforementioned aspects may exhibit one or more of the following preferred features.

Preferably bringing said two terminally opposite folding lines into substantial mutual contact comprises bringing said two support elements to a mutual minimum distance. In this way the achievement of substantial mutual contact is facilitated.

Preferably said mutual minimum distance is less than said mutual initial distance. Preferably said mutual minimum distance is less than or equal to twice a thickness of said sheet. In this way a desired degree of substantial mutual contact is easily achieved.

Preferably said method further comprises, more preferably subsequently to said applying said gluing material and even more preferably previously to said coupling said base layer, arranging said two support elements at a non-zero mutual final distance, more preferably while keeping said sheet on holding onto said two support elements. In this way, by appropriately distancing the support elements from each other, it is possible to achieve a desired degree of opening of the sheet fold to adapt the article to the objects it will house once in the package. Preferably said final distance is less than said initial distance. In this way, a desired three-dimensional shape of the folded sheet is maintained.

Preferably said coupling said base layer is performed while keeping said sheet on holding onto said two support elements. In this way, the maintenance of the desired shape of the folded sheet is facilitated.

In one embodiment, said method comprises adjusting said mutual final distance as a function of a use destination of said article, for example as a function of a type and/or size of an object housed by said article. In this way, the versatility of the method is facilitated. Preferably with said two terminally opposite folding lines into substantial mutual contact, two portions of said sheet external to said fold and arranged each one adjacent to a respective folding line of said two terminally opposite folding lines are mutually coplanar, more preferably in a horizontal plane. In other words, the portions of the sheet not involved in the fold (i.e., not included between the folding lines) form a substantially continuous planar surface. In this way, the application of the gluing material is facilitated, particularly if the planar surface created is positioned in a horizontal plane (so as to accommodate the gluing material).

Preferably applying said gluing material is performed on at least one of said two portions of said sheet. More preferably applying said gluing material is performed according to a dot pattern (of gluing material application).

Preferably said dots (of gluing material application) are arranged along at least two rows. Preferably said at least two rows are parallel. Preferably, at least two dots (of gluing material application) are provided for each of said two portions of said sheet. In this way, adhesion is facilitated without excess of gluing material.

Preferably said gluing material is a hot melt adhesive. The Applicant has indeed found that the short drying times of hot melt adhesive are particularly compatible with the high production speeds of industrial manufacturing processes.

Preferably said base layer comprises a respective sheet having a flat shape. In this way, strength is imparted to the article while limiting the increase in weight.

Preferably, said respective sheet of the base layer is made of the same material as said sheet. In one embodiment, said same material is a material containing, or more preferably based on, cellulose, such as paper or cardboard. In this way, the article is robust yet lightweight. Furthermore, such materials are relatively cost-effective and easily recyclable.

In a preferred embodiment, providing said plurality of support elements comprises providing two or more pairs of directly consecutive support elements including said two support elements. Preferably said plurality of support elements comprises two or more pairs of directly consecutive support elements including said two support elements. Preferably, each pair of support elements shares a support element with a directly consecutive pair of support elements.

Preferably, said control unit is programmed for commanding each pair of support elements similarly to said two support elements. In this way, it is possible to form a fold on the sheet for each pair of support elements, and thus a plurality of folds, achieving the effects described above.

Preferably directly consecutive support elements of each pair are placed at a non-zero mutual initial distance.

Preferably said method comprises making a plurality of folds on said sheet by performing, for each pair of support elements, at least the aforementioned steps of the method according to the first aspect of the present invention, from arranging a sheet on holding to reciprocally approaching the support elements, to bringing two terminally opposite fold lines into substantial mutual contact, to applying a gluing material. In other words, with reference to the respective two support elements of each pair of support elements, the following steps are to be performed:
arranging the sheet on holding onto said respective two support elements;
reciprocally approaching said respective two support elements for making on said sheet a respective fold comprising at least three respective folding lines arranged in respective spatial sequence on said sheet;
bringing two respective terminally opposite folding lines into substantial mutual contact of said respective sequence of said at least three respective fold lines;
with said two respective terminally opposite folding lines into substantial mutual contact, applying a gluing material on said sheet at opposite side to said respective two support elements.

In this way, the article is further versatile depending on the various intended uses.

Preferably coupling said base layer is performed once the previous steps are executed for each pair of support elements, including said two support elements. In this way, the process is further simplified and expedited.

Preferably making said plurality of folds on said sheet comprises making said plurality of folds in a temporal sequence by reciprocally approaching support elements of each pair of directly consecutive support elements mutually closer, proceeding one pair at a time. In an equally preferred manner, making said plurality of folds on said sheet comprises making said plurality of folds simultaneously by reciprocally approaching support elements of each pair of directly consecutive support elements mutually closer, proceeding for all pairs simultaneously. In other words, the folds can be formed in a temporal sequence one after the other or all simultaneously.

Preferably said method comprises providing a linear transport system.

Preferably said machine comprises said linear transport system.

Preferably said linear transport system comprises a fixed linear guide, more preferably, said fixed linear guide defines a processing path.

Preferably said fixed guide has a main development line with closed path. In this way, the efficiency of the machine is increased.

Preferably said main development line lies (entirely) on a (substantially) vertical support surface. In this way, the footprint is further minimized.

Preferably it is provided to arrange said plurality of support elements sliding engaging said fixed guide. In this way, the footprint of the machine is kept limited (which may substantially coincide with the footprint of the linear guide), and it is also possible to provide the machine to be easily integrated into a continuous production line, where, for example, the sheet, held onto the support elements, travels through a series of subsequent stations that contribute to the creation of the article starting from the sheet. Preferably said linear transport system is structured for moving, more preferably by means of said control unit, each support element under sliding along said fixed guide, more preferably independently from the remaining support elements. In other words, the linear transport system allows independent control of the movement of each support element along the guide (e.g., by precisely controlling a respective motion law for each support element). In this way, the realization of the fold is facilitated, making complex movement systems for, and/or synchronization between, the various support elements superfluous, while keeping the machine structurally simple. Furthermore, the Applicant has found that by means of the aforementioned linear transport system, to create the folds of the sheet, it may be sufficient to bring the respective support elements closer together, making the provision of folding elements (such as those described later) and related actuation systems unnecessary. Moreover, thanks to the aforementioned linear transport system, it is possible to perform, with the same machine, different folding programs, such as multiple folds simultaneously or in a temporal sequence, benefiting from reduced times and structural simplicity and versatility. Preferably each support element comprises a respective trolley engaging said fixed guide.

Preferably each support element comprises a respective independent drive unit, preferably associated with said respective trolley. In this way, the possibility of moving each support element along the fixed guide independently from the other support elements is realized in a structurally simple manner.

Preferably said linear transport system comprises a contactless communication sub-system (e.g., transmission and/or reception) of a signal (e.g., power signal and/or data signals) between said fixed guide and each support element (more preferably the respective drive unit and/or a respective processing unit incorporated on the support element), and/or vice versa. For example (and preferably), the signals may be reciprocally transmitted by inductive coupling between one or more stationary coils arranged on the fixed guide and one or more respective coils arranged on each of the support elements. In this way, the coupling is simple, direct, free from friction (and thus free from issues related to wear of parts), and capable of enabling reciprocal signal transmission both with the support elements stationary and in motion along the guide.

Preferably said control unit is connected to said communication sub-system to control said two support elements, more preferably said plurality of support elements, by means of, and/or based on, said signal. Preferably, each drive unit is structured to be operated (e.g., powered and/or controlled) by means of said communication sub-system, more preferably by said control unit.

Preferably said machine comprises a loading station, preferably arranged along said processing path. Preferably, said first deposition system is arranged at said loading station.

Preferably said machine comprises a folding station, more preferably arranged downstream of said loading station along the processing path.

Preferably reciprocally approaching said two support elements (or support elements of each pair of support elements) for making on said sheet said fold is performed at said folding station.

For example, the folding station comprises a section of the fixed guide where the reciprocal approach of the two support elements occurs.

Preferably said folding station comprises at least one folding plane.

Preferably said folding plane intersects said processing path (e.g., intersects the direction of movement of the support elements).

More preferably, said folding plane is orthogonal to said processing path (e.g., orthogonal to the direction of movement of the support elements).

The folding plane represents, for example, a virtual central symmetry plane of the fold of the sheet. For example, the central folding line of said at least three folding lines of said fold can lie on this folding plane, with the terminally opposite folding lines being arranged (in at least one spatial configuration of the support elements) on opposite parts of the folding plane. This folding plane can be, for example, unique for all the folds (if they occur in temporal sequence at the same point), or a plurality of mutually parallel planes can be provided, each for one or more respective folds. Furthermore, the folding plane can be spatially fixed with respect to the fixed guide, or movable (for example, if the fold is executed with the support elements in motion, the folding plane moves along the guide as the fold is formed).

In one embodiment, said method comprises, more preferably during said reciprocally approaching said two support elements, moving a folding element towards said two support elements to bring said folding element into contact with said sheet at a portion of said sheet interposed, preferably cantilevered, between said two support elements. In this way, the formation of the fold is facilitated, for example, by directing the deformation of the sheet into the desired half-space (relative to the plane of the sheet).

In one embodiment, said machine comprises said folding element. Said folding element is preferably alternately movable from one or more distal positions from said two support elements to a proximal position relative to said two support elements, more preferably where said folding element lies on said folding plane. Preferably, when in said proximal position, said folding element contacts said portion of said sheet cantilevered between said two support elements.

In one embodiment, said folding element comprises a rotating element eccentrically rotating around a respective axis of rotation.

Preferably, said axis of rotation is horizontal, more preferably perpendicular to said processing path. Alternatively, said axis of rotation is parallel to the processing path.

Preferably, reciprocally approaching said two support elements is performed while keeping said plurality of support elements under movement along said processing path with the same direction of movement.

In one embodiment, said movement is continuous. In other words, the support elements never stop along the processing path during the formation of the fold(s) (but only undergo accelerations and/or decelerations in order to bring them closer together). In this way, the cycle time is minimized.

Preferably, reciprocally approaching said respective two support elements comprises varying a respective movement speed of at least one of said two respective support elements.

Preferably, reciprocally approaching said two support elements comprises at least one of: slowing down a support element of said two support elements arranged further downstream along said processing path, and accelerating a support element of said two support elements arranged further upstream along said processing path. In this way, the approach is achieved in a simple and easily controllable manner.

Preferably arranging said sheet on holding onto said two support elements comprises applying a holding action on said sheet by means of at least said two support elements of said plurality of support elements. Equally preferably, it may be provided to place a sheet on hold onto all the support elements of said plurality of support elements and apply a holding action on said sheet by means of all the support elements of said plurality of support elements (for example, whether the remaining support elements actively participate in the formation of the fold by reciprocally approaching or not).

Preferably arranging said sheet on hold comprises applying one or more of the following techniques: suction of said sheet by application of vacuum, electro-adhesion, fastening by means of mechanical locking members. These techniques have proven efficient in terms of adhesion effectiveness and compatibility with the support elements.

Preferably, each of said two support elements comprises a respective support face structured for supporting said sheet. More preferably, each support element comprises a respective support face structured to support said sheet.

Preferably, each support face has a planar shape. In this way, the holding of the sheet is facilitated by encouraging mutual interaction between the sheet and the support face, especially when the sheet is held by vacuum application (e.g. suction) or electro-adhesion. Even in the case of mechanical clamping elements, the planar support face simply facilitates the holding of the sheet.

Preferably (more preferably in at least one spatial configuration of each support element of said two support elements), the support faces of said two support elements are coplanar to each other in a horizontal plane. In this way, the realization of the article is facilitated, for example, the application of the gluing material and the deposition of the base layer on the sheet when the sheet lies on the bearing surfaces arranged horizontally.

Preferably, said dispensing system comprises at least one dispensing nozzle, more preferably a pair of dispensing nozzles, directed towards at least one of said support faces (more preferably for at least one spatial configuration of the support element). In this way, the dispensing of the gluing material is simple.

Preferably, said machine comprises a coupling station, more preferably disposed downstream of said folding station along said processing path. Preferably, said second deposition system is disposed at said coupling station.

Preferably, said method comprises, more preferably before coupling said base layer to said sheet, applying to at least one of said sheet and said base layer, a label and/or an adhesive. Preferably, said label and/or adhesive are of the acousto-magnetic (AM) type or of the radio frequency (RF) type. In this way, the article is (electronically) traceable.

Preferably, said method comprises, subsequent to said coupling of said base layer to said sheet, moving said article along said processing path to a discharge station arranged along said fixed guide, more preferably downstream of said coupling station along said processing path. Preferably, said method comprises unloading said article from said two (more preferably said plurality of) support elements at said discharge station.

In one embodiment, at said discharge station, said article is rotated by 180° relative to a position of said article upstream of said discharge station, for example at said coupling station. In this way, the article is already appropriately oriented to receive the objects.

Preferably, said machine comprises a discharge station, more preferably arranged downstream of said folding station (even more preferably downstream of said coupling station) along said processing path. Preferably, said discharge station is structured to unload said article from said two (more preferably said plurality of) support elements.

In one embodiment, said machine comprises a handling element structured to remove said article from said two (more preferably from said plurality of) support elements and to deposit said article in a discharge bay. Preferably, when the article is in the discharge bay, it is rotated by 180° relative to a position of the article when upstream of the discharge station, for example, when in the coupling station.

Preferably, all of said loading station, folding station, coupling station, and unloading station are arranged at the same vertical level. In this way, the machine is simple.

It is specified that some steps of the method described above may be independent of the execution order provided, except where a sequential or simultaneous relationship between two or more steps is expressly indicated. Furthermore, some steps may be optional. Additionally, some steps may be performed repetitively, or they may be executed in series or in parallel with other steps of the method.

### BRIEF DESCRIPTION OF THE FIGURES

FIG. 1 schematically shows a perspective view of a machine according to the present invention;

FIG. 2 shows a diagram of the machine from FIG. 1;

FIGS. 2a and 2b schematically show variants of some components of the machine according to the present invention;

FIG. 3 shows a detail from FIG. 1;

FIG. 4 shows a top view of FIG. 3;

FIGS. 5-8 schematically show some phases of a method for producing an article according to an embodiment of the present invention;

FIG. 9 shows an article produced using the producing method according to an embodiment of the present invention.

### DETAILED DESCRIPTION OF SOME EMBODIMENTS OF THE INVENTION

The characteristics and advantages of the present invention will be further clarified by the following detailed description of some embodiments, presented by way of example and not limitation of the present invention, with reference to the attached figures.

In the following description, the same numerical references will be used to identify similar elements, even in their different embodiments.

In the figures, the number 1 generally refers to a machine for producing an article A comprising a folded sheet F. Preferably the sheet F is made of cellulose-based material, i.e., paper or cardboard. Alternatively, the sheet may be made of polymeric or metallic material.

Exemplarily machine 1 comprises a control unit 10 for commanding various components and/or systems and/or elements of machine 1, as will be further described below. Exemplarily machine 1 comprises a linear transport system 2, comprising a linear fixed guide 3 that defines a processing path. For example, the linear transport system 2, as such, may be of the type described in US2021/0046826 A1, as far as compatible here. Exemplarily machine 1 further comprises a plurality of support elements 4 mutually movable that engage and slide along the fixed guide 3.

Exemplarily the plurality of support elements 4 consists of at least one package of five support elements 4, arranged in succession along the fixed guide 3, which contribute to making four distinct folds P on the same sheet F, as will be further described below (see also FIG. 9).

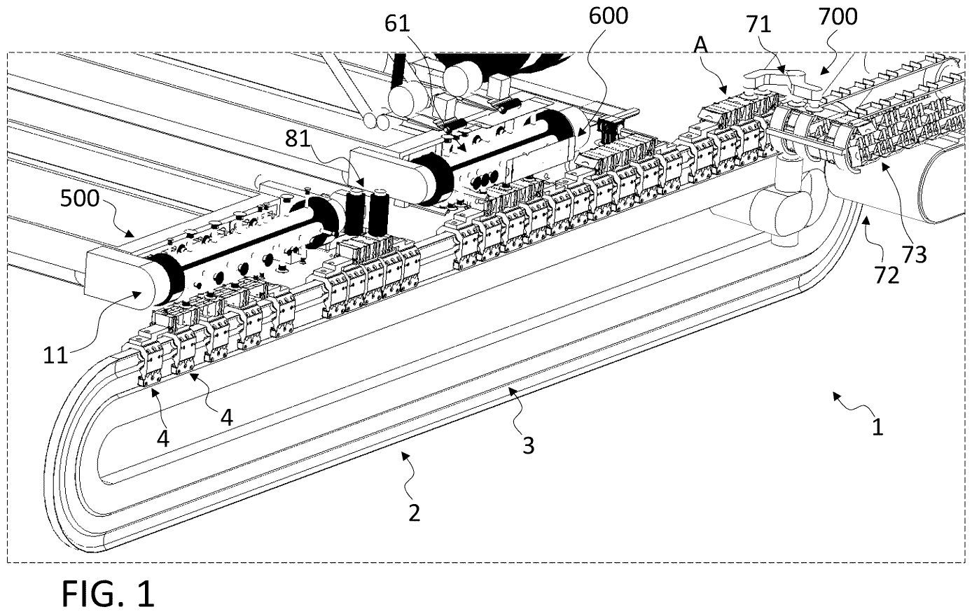

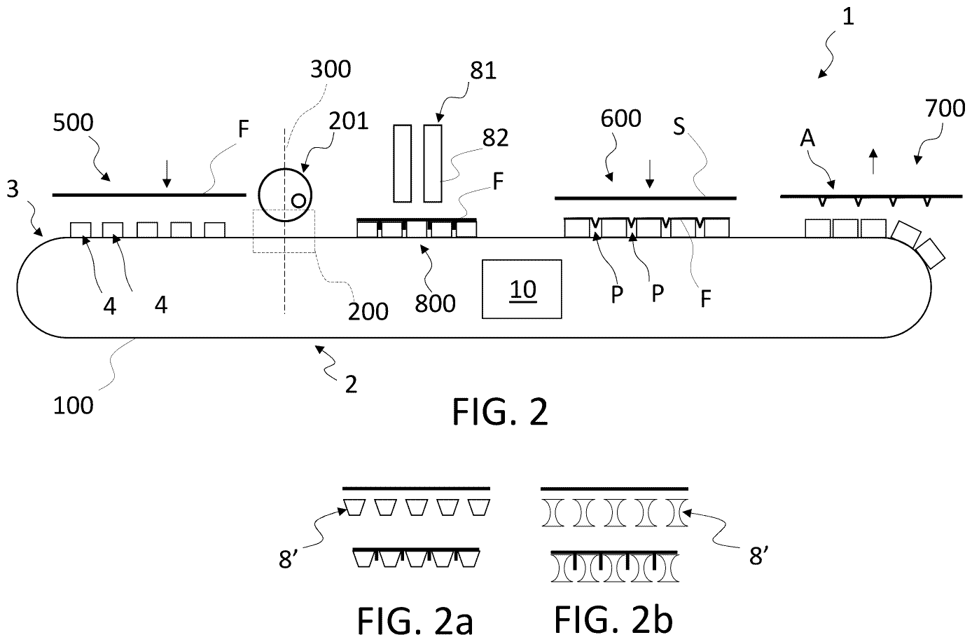

The fixed guide 3 is shown in its entirety in FIG. 1, while in FIG. 2, the fixed guide 3 is represented in a purely schematic way by a line that represents its main development line 100 (i.e., the line along which the largest physical dimension of the fixed guide 3 extends). This main development line 100, travelled in a predetermined direction of movement by the support elements 4 (clockwise in the figures), identifies the aforementioned processing path. Exemplarily, the main development line 100 is a closed loop, so that the support elements 4 can continuously circulate along the fixed guide 3 to carry out multiple successive cycles of article production.

Exemplarily the main development line 100 lies entirely on a flat support surface disposed vertically (in FIG. 2 coinciding with the plane of the figure).

In unshown embodiments, the main development line 100 can have any development in space. In such embodiments, the main development line can advantageously lie entirely on a surface, not necessarily flat, of vertical support. In other words, opposite portions of the fixed guide 3, which respectively represent a forward section and a return section of the support elements 4, are, at every point of the fixed guide 3, vertically superimposed to each other.

Exemplarily the linear transport system 2 is structured to move, by means of the control unit 10, each support element 4 sliding along the fixed guide 3 independently from the remaining support elements 4.

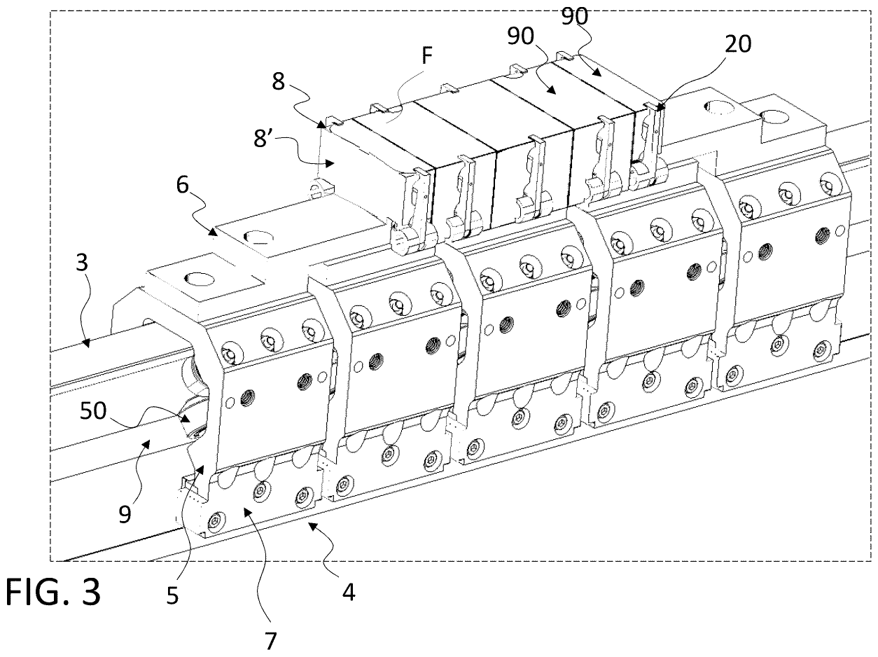

To this end, advantageously, each support element 4 comprises a respective trolley 5, engaging the fixed guide 3, and a respective independent drive unit 7, associated with the respective trolley 5. For example, the trolley 5 may comprise one or more rollers 50 (FIG. 3) in rolling contact with a sliding surface 9 of the fixed guide 3.

Exemplarily (not shown), the linear transport system 2 further comprises a contactless communication subsystem (e.g. transmission and/or reception) of a signal (e.g. power signal and/or data signals) between the fixed guide 3 and each support element 4 (for example, the respective drive unit 7 and/or a respective processing unit embedded on the support element, not shown) and vice versa. For example (not shown), the power and data signals can be mutually transmitted via inductive coupling between one or more stationary coils arranged on the fixed guide 3 and one or more coils arranged on each of the support elements 4.

Exemplarily the control unit 10 is connected to the communication subsystem to control the support elements 4, by means of, and/or based on, the aforementioned signal.

In more detail, each drive unit 7 is structured to operate (e.g., be powered and/or controlled) through the communication subsystem, by the control unit 10 of machine 1. In this regard, respective processing units potentially provided on the trolley 5 of the support elements 4 can be conceptually considered part of the control unit 10 of the machine, as they are typically connected to it, for example, through the aforementioned communication system.

With reference to FIGS. 1 and 2, machine 1 comprises a loading station 500 arranged along the processing path.

Machine 1 may comprise a first deposition system 11 structured to place the sheet F on the support elements 4. The first deposition system 11 is arranged at the loading station 500, near a respective section of the fixed guide 3.

The first deposition system may comprise a roller equipped with gripping elements (e.g., a row of suction cups) capable of reversibly gripping the sheet F.

Each support element 4 may further comprise a respective supporting face 8 structured to support the sheet F. Each supporting face 8 has a planar shape, with the supporting faces 8 of the support elements 4 being, for example, coplanar in a horizontal plane at least in one spatial configuration of the support elements 4. Specifically, by spatial configuration of the support elements, it refers to a position in space of the support elements along the fixed guide 3.

Exemplarily it is observed that this spatial configuration, in which the supporting faces 8 are coplanar in a horizontal plane, is achieved through a continuum of spatial positions of the support elements 4 along the upper straight section of the fixed guide 3.

Exemplarily each supporting face 8 represents an end face (upper, opposite to the fixed guide 3) of a supporting portion 8′ having a three-dimensional shape, for example, a parallelepiped, of each support element 4 (FIG. 3).

Such supporting portions 8′ may alternatively take shapes different from the parallelepiped shape shown in FIG. 3, such as an inverted pyramid frustum shape (with a trapezoidal shape when viewed laterally) as very schematically shown in FIG. 2a, or complex shapes, such as the substantially “hourglass” shape of FIG. 2b.

Exemplarily (FIG. 3), the support elements 4 disposed in the two extreme positions of the support element package 4 (i.e., the first, second, fourth, and fifth support elements of the package) each comprise a respective support arm 6 (of greater length for the first and fifth support elements 4) that extends away from the respective trolley 5, bringing the respective supporting portion 8′, in particular the supporting face 8, located at one end of the support arm 6, close to at least the supporting portion 8′ of the directly adjacent (previous or next) support element 4.

Machine 1 may further comprise a folding station 200 (schematically outlined by the dashed rectangle shown in FIG. 2) disposed downstream of the loading station 500 along the processing path. The folding station corresponds to a section of the processing path at which the folds of the sheet are made.

In said folding station 200, a folding plane 300 is defined, exemplarily shown in the figures by a dashed line.

Machine 1 may comprise a folding element 201, exemplarily comprising a rotating element eccentrically around a respective horizontal axis of rotation and perpendicular to the processing path. In the example shown, the eccentric rotating element is realized by a wheel from which a bar protrudes, parallel to the rotation axis of the wheel, positioned off-center on the wheel with respect to the axis of rotation.

In one embodiment (not shown), the machine may be devoid of folding elements. In this configuration, the folds are created solely by the reciprocal approach of the support elements (as described in more detail below). Although not shown, it is also possible in this embodiment to define one (or more) folding planes.

Alternatively (not shown) the folding element may be movable along a purely vertical trajectory, alternately from a distal position from the fixed guide to a proximal position to the fixed guide.

The linear transport system 2 may, for example, comprise one or more further pluralities of support elements 4 slidably engaging the same fixed guide 3 simultaneously with the aforementioned plurality of support elements 4.

For example, in FIGS. 1 and 2, five and four distinct pluralities of support elements 4 are respectively depicted, simultaneously engaging the same fixed guide 3 in correspondence with different spatial portions of the processing path (corresponding to different phases of the method for manufacturing the article according to the present invention, as better described below). Alternatively, the multiple distinct pluralities of support elements 4 shown in FIGS. 1 and 2 may also be interpreted as the same plurality of support elements 4 depicted at different (e.g., successive) temporal stages of the method.

Machine 1 may further comprise a dispensing system 81 structured to dispense a gluing material. The dispensing system is arranged in correspondence with a gluing station 800 of the machine downstream of the folding station 200 along the processing path.

The dispensing system 81 may comprise a pair of dispensing nozzles 82 arranged above the fixed guide 3 and oriented towards the fixed guide 3 so as to be directed towards the support portions of the support elements 4 when passing through the gluing station 800. Machine 1 may also comprise a coupling station 600, arranged downstream of the folding station 200 along the processing path. Machine 1 may comprise a second deposition system 61 structured to place a base layer S in correspondence with the plurality of support elements 4, the second deposition system 61 being arranged at the coupling station 600.

Exemplarily the second deposition system is structurally similar to the first deposition system. Exemplarily the base layer S is also a flat sheet made of paper-based material. Machine 1 may further comprise, for example, a discharge station 700 located downstream of the coupling station 600 along the processing path. For example, the discharge station is structured to discharge the article A from the plurality of support elements 4. To this end, the machine comprises a handling element 71 structured to remove the article A from the plurality of support elements 4 and to deposit the article in a discharge bay 72. Specifically, in the discharge bay 72, the article is rotated by 180° relative to a position of the article when upstream of the discharge station, for example, when still resting on the support elements 4. For example, the discharge bay 72 is equipped with a conveyor roller 73 to convey the article towards further processing. The 180° rotation is performed by this conveyor roller 73, as shown in FIG. 1.

Exemplarily the loading station 500, the folding station 200, the gluing station 800, the coupling station 600, and the discharge station 700 are all arranged at the same vertical level (FIGS. 1 and 2).

In use, machine 1 enables the execution of a method for producing an article A comprising a folded sheet F.

For example, the method initially includes arranging the sheet F on holding on the plurality of support elements 4 at the loading station 500. Exemplarily, the support elements 4 of each pair are positioned at a respective a non-zero mutual initial distance D0 from each other. The initial distances between them are exemplarily equal for each pair of support elements 4. In other words, the support elements 4 are all equidistant when at the loading station 500.

Exemplarily the method includes, for producing the article, moving the plurality (or each plurality) of support elements 4 along the processing path, so that the plurality of support elements 4 along with the sheet F sequentially passes through each of the stations of the machine described above. The steps of the method that will be described next thus include, for example, the continuous advancement, or with stops at specific points, of the plurality of support elements 4 along with the sheet F along the fixed guide 3, from the loading station 500 to the discharging station 700.

Sheet F is initially placed on the support elements 4 at the loading station 500 by means of the first deposition system 11, suitably commanded by the control unit 10.

The holding of the sheet can be achieved by two or more (preferably all) support elements 4, for example, at the respective support portions 8. In the embodiment shown, the holding is accomplished by mechanical locking members 20, shown in FIGS. 2 and 3, structured to hook and lock the sheet against the support portions. The mechanical locking members include locking elements (e.g., levers) structured to close (for example, by rotation around an axis) on the sheet F when it is resting on the support portions. Other examples may include clamps, piezoelectric microactuators, etc.

Alternatively or in combination with the aforementioned mechanical members, the following techniques may also be used: sheet suction through the application of vacuum, electro-adhesion. Electro-adhesion refers to the ability to attract a material towards a surface by generating reversible electric fields to which the material is subjected at that surface.

The method comprises, in conjunction with the passage of the support elements 4 through the bending station 200, reciprocally approaching the respective two support elements 4 of each pair for making on the sheet F a respective fold P, each fold comprising at least three respective fold lines P1a, P1b, P1c arranged in respective spatial sequence on the sheet.

The control unit 10 is configured to control each support element 4 to reciprocally approach each directly consecutive pairs of support elements 4 for making the respective folds P.

With reference to FIGS. 2 and 9, each fold P comprises, for example, only three respective folding lines P1a, P1b, P1c, thereby creating a triangular-shaped fold in the lateral view of the sheet. The folding lines P1a, P1b, P1c of each fold are distinct from each other and are preferably parallel to one another, with all of them being perpendicular to the direction of movement of the sheet F along the processing path.

The folding lines of each fold are arranged in the sequence P1a, P1b, P1c, where the folding line P1b is positioned between the folding lines P1a and P1c, with the latter being the terminally opposite folding lines of the fold (i.e., positioned at the two ends of the sequence P1a, P1b, P1c).

The folds P made on the sheet shown in the figures are four.

In alternative embodiments (not shown), the folds may be of any number and/or include more than three folding lines.

Exemplarily, since the linear transport system 2 is structured to move each support element 4 sliding along the fixed guide 3 independently of the other support elements 4, for example through the aforementioned drive units 7 and the communication subsystem under the control of control unit 10, the independent movement of each support element allows the creation of folds to be advantageously performed in multiple ways, all while maintaining the structural simplicity of the machine.

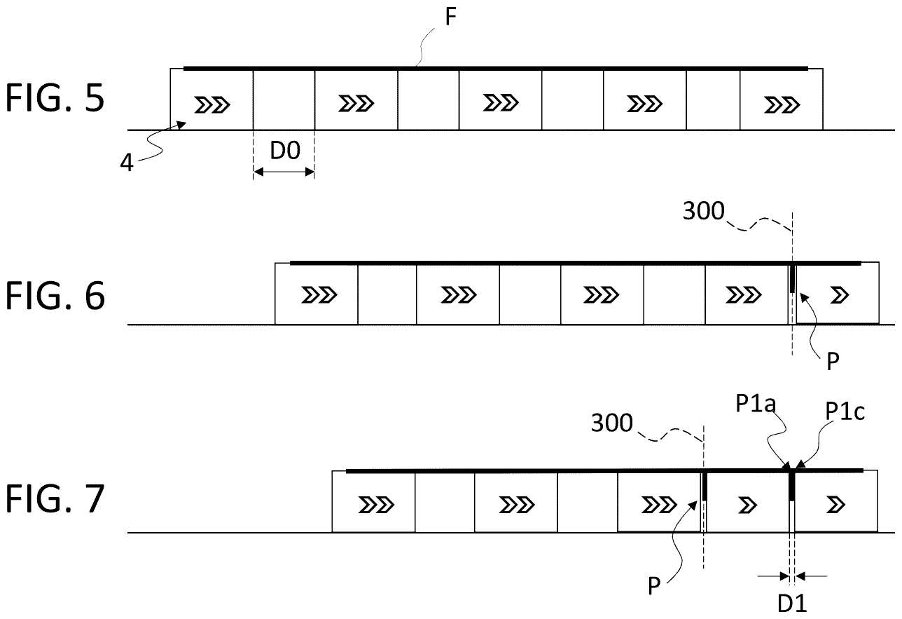

Exemplarily the folds P are made while keeping the plurality of support elements 4 in motion along the processing path in the same direction of movement. In other words, the support elements 4 never stop along the processing path during the creation of the folds. A situation like this is schematically represented in FIGS. 5-7.

FIG. 5 schematically shows the plurality of support elements 4 moving along the fixed guide 3, all at the same speed (e.g., constant with the same direction and direction, symbolized by the double arrows), and all at the same mutual initial distance D0, so that the sheet F is at rest (e.g., not stretched or folded) on the support elements.

Reciprocally approaching the two respective directly consecutive support elements of each pair may include, for example, varying the respective movement speed of at least one of the two respective support elements, such as slowing down a support element located further downstream along the processing path.

By appropriately adjusting the motion laws of each support element 4 independently, it is possible to create the desired folds in a temporal sequence, as shown in FIGS. 6 and 7 described below.

In FIG. 6, the support element 4 positioned furthest to the right in the plurality (i.e., the support element positioned furthest downstream) has undergone deceleration (as shown by the single arrow), while the directly adjacent support element (the one positioned further upstream) has maintained its constant initial speed, thereby reducing the distance between it and the downstream support element, resulting in the formation of the first fold on the sheet F.

FIG. 7 shows a subsequent phase, where the second support element 4 from the right has also been decelerated (as shown by the single arrow), while the third support element 4 maintains its speed, resulting in the formation of a second fold, and so on.

In this embodiment, the folding plane 300 can generally be translationally moved along the fixed guide 3.

Machine 1, according to the embodiment described here, can be advantageously suited for the creation of folds without the complete stoppage of the support elements 4.

In the presence of the bending element 201, as shown in FIG. 2, the bending element 201 is rotated in sync with the reciprocal approach of the support elements 4, so that the eccentric bar contacts the sheet F, at a portion of the sheet that is suspended between the respective two support elements 4, when these two support elements 4 pass through the bending station 200. This operation is exemplarily repeated for each pair of support elements 4.

The bending element 201, in its movement from a distal to a proximal position, exemplarily makes only a brief contact with the sheet (e.g., without reaching the bottom of the bend), sufficient to guide the sheet in the correct bending direction (e.g., towards the fixed guide 3).

In addition to or as an alternative to the bending elements, the sheet F (not shown) can also be subjected, prior to the bending method, to a scoring process to prepare the sheet for the folds (typically, scoring is performed in the paper mill). For example, scoring involves creating grooves (e.g., by pressing with appropriate rollers) on one side of the sheet, possibly also creating corresponding raised areas on the opposite side. These score lines facilitate the bending of the sheet (which typically occurs so that the concavity of the bend is on the same side as the groove created by the scoring). Typically, the fold lines will be formed in correspondence with the score lines.

In one embodiment, a bending element in the proximal position is in contact with the sheet at a surface of the sheet that does not include any scoring.

The method therefore includes placing the respective two terminally opposite folding lines, P1a and P1c, of each respective sequence of three folding lines of each fold in substantial mutual contact. In other words, the support elements 4 of each pair of support elements 4 are positioned, by the control unit 10, at a mutual minimum distance D1 smaller than the mutual initial distance D0, creating a packing of the support elements 4 that grip, between each pair of support elements 4, a respective fold P of the sheet (FIG. 7). For example, the minimum mutual distance D1 is approximately equal to twice the thickness of the sheet F. This situation is exemplarily shown in detail in FIGS. 3, 4, and 7.

It is therefore provided, with the respective two terminally opposite folding lines P1a and P1c in substantial mutual contact, to apply a gluing material to the side of the sheet F opposite the support elements 4.

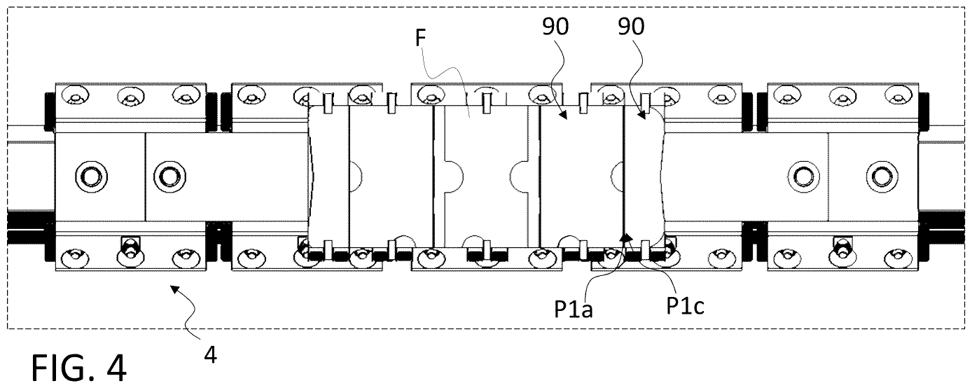

With the respective two terminally opposite folding lines P1a and P1c in substantial mutual contact, two portions 90 of the sheet F, external to each respective fold P and each adjacent to a respective folding line P1a, P1c of the respective two terminally opposite folding lines, are coplanar with each other in a horizontal plane. In other words, the portions of the sheet that rest on the support faces 8 of the support elements 4, when the support elements 4 are packed as described above, collectively form a substantially continuous surface arranged horizontally. This situation is exemplified in FIGS. 3 and 4. Exemplarily the gluing material is applied in a dot pattern arranged along two parallel rows, with two dots for each of the portions 90 of the sheet external to the fold. Each of the two dispensing nozzles 82 of the dispensing system 81 can create a respective row of gluing points. Advantageously, the gluing material is a hot-melt adhesive, or includes hot-melt adhesive.

The application of the gluing material takes place with the support elements 4 at the bonding station 800.

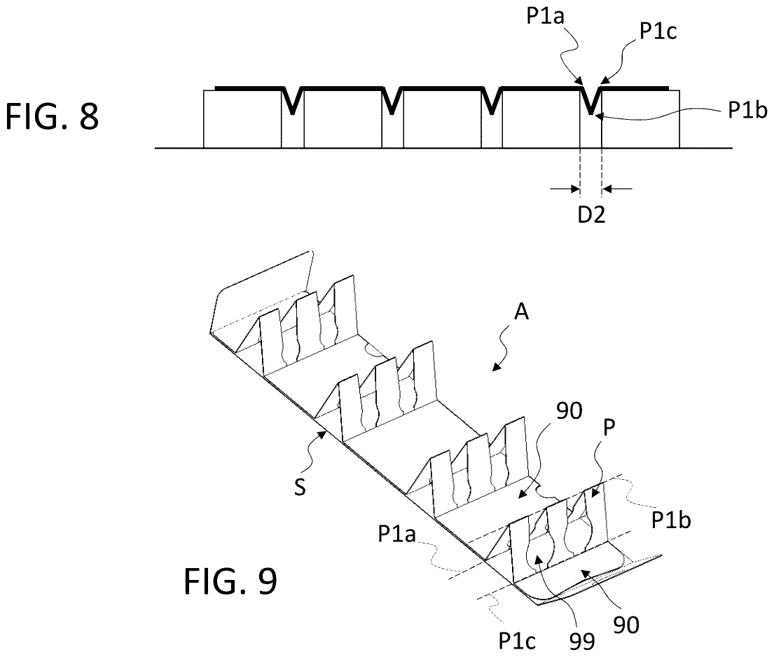

The method thus comprises the step of bonding a base layer S to the sheet F with the gluing material interposed between the base layer S and the sheet F, to create the article A. The method may also comprise, after applying the gluing material and before attaching the base layer S, adjusting the distance between the two support elements 4 of each support element pair to a final non-zero distance D2, while keeping the sheet F held on the support elements 4, as shown in FIG. 8.

This configuration of the support elements at the final distance D2 is also schematically shown in FIG. 2, in correspondence with the coupling station 600 of machine 1. The final distance D2 is shown as equal for all the support elements 4 and is smaller than the initial distance D0 (so as to maintain a three-dimensional development of the folds in the sheet). Exemplarily the coupling of the base layer S is performed at the coupling station 600, keeping the sheet F in retention on the support elements 4. The positioning of the base layer S above the sheet F is carried out by the second deposition system 61, controlled by the control unit 10.

After the coupling with the base layer S, the article A is moved along the processing path to the discharging station 700, where article A is discharged from the plurality of support elements 4. It is placed into the discharge bay 72 by the handling element 71, which arranges article A on the conveyor roller 73 to be transported toward further processing stages, such as insertion into packaging and the arrangement of items in the article.

With reference to FIG. 9, it shows in detail a perspective view of an article A produced using the method according to an embodiment of the present invention. Article A consists of a total of four folds P, each comprising three respective folding lines P1a, P1b, P1c (dashed lines), forming portions of the sheet F that protrude three-dimensionally from the original plane of the sheet. Between each fold, portions 90 are visible, which, during use, rest on the support faces 8 of the support elements 4. Below the sheet F, the base layer S is partially visible.

As can be observed, the sheet F comprises through holes 99 (exemplarily of different shapes for some folds compared to others), which are appropriately distributed across the sheet F so that, once the folds are made, they align with the respective folds. These through holes 99 create accommodation spaces for objects (not shown) that will be housed in article A. The housed objects typically have their respective ends held in place, each by a respective fold via a corresponding through hole 99.

1. A method for producing an article comprising a folded sheet said method comprising the steps of:
i) providing a plurality of support elements mutually movable, two directly consecutive support elements of said plurality of support elements being placed at a non-zero mutual initial distance;
ii) arranging a sheet on holding onto said two support elements;
iii) reciprocally approaching said two support elements for making on said sheet a fold comprising at least three folding lines arranged in spatial sequence on said sheet;
iv) bringing two terminally opposite folding lines of said at least three folding lines into substantial mutual contact;
v) with said two terminally opposite folding lines into substantial mutual contact, applying a gluing material on said sheet at opposite side to said two support elements;
vi) coupling a base layer to said sheet with said gluing material interposed between said base layer and said sheet, for producing said article.

2. The method according to claim 1, wherein bringing said two terminally opposite folding lines into substantial mutual contact comprises bringing said two support elements to a mutual minimum distance less than said mutual initial distance said mutual minimum distance being less than or equal to twice a thickness of said sheet.

3. The method according to claim 1, comprising, subsequently to said applying said gluing material and previously to said coupling said base layer, arranging said two support elements at a non-zero mutual final distance while keeping said sheet on holding onto said two support elements, and wherein said coupling said base layer is performed while keeping said sheet on holding onto said two support elements arranged at said mutual final distance.

4. The method according to claim 1, comprising, during said reciprocally approaching said two support elements, moving a folding element towards said two support elements to bring said folding element into contact with said sheet at a portion of said sheet interposed between said two support elements.

5. The method according to claim 1, wherein, with said two terminally opposite folding lines into substantial mutual contact, two portions of said sheet external to said fold and arranged each one adjacent to a respective folding line of said two terminally opposite folding lines are mutually coplanar in a horizontal plane, and wherein applying said gluing material is performed on at least one of said two portions of said sheet.

6. The method according to claim 5, wherein said applying said gluing material is performed according to a dot pattern, with at least two dots for each of said two portions of said sheet.

7. The method according to claim 1, comprising providing a linear transport system comprising a fixed linear guide defining a processing path, and said plurality of support elements slidingly engaging said fixed guide, wherein said linear transport system is structured for moving each support element under sliding along said fixed guide independently from the remaining support elements, and wherein reciprocally approaching said two support elements is performed while keeping said plurality of support elements under movement along said processing path with same movement direction.

8. The method according to claim 7, wherein reciprocally approaching said two support elements comprises at least one of: slowing down a support element of said two support elements arranged further downstream along said processing path and accelerating a support element of said two support elements arranged further upstream along said processing path.

9. The method according to claim 1, wherein providing said plurality of support elements comprises providing two or more pairs of directly consecutive support elements including said two support elements, each pair of support elements sharing a support element with a directly consecutive pair of support elements, wherein directly consecutive support elements of each pair are placed at a non-zero mutual initial distance wherein said method comprises making a plurality of folds on said sheet by performing, for each pair of support elements, at least the steps from ii) to v).

10. The method according to claim 1, wherein arranging said sheet on holding comprises applying one or more of the following techniques: suction of said sheet by application of vacuum, electro-adhesion, fastening by mechanical locking members.

11. A machine for producing an article comprising a folded sheet, said machine comprising:
a plurality of support elements mutually movable, two directly consecutive support elements of said plurality of support elements being structured for holding a sheet when arranged onto said two support elements;
a first deposition system structured for arranging said sheet onto said two support elements;
a second deposition system structured for arranging a base layer at said two support elements;
a dispensing system structured for dispensing a gluing material;
a control unit programmed for:
bringing said two support elements at a non-zero mutual initial distance;
arranging said sheet onto said two support elements by means of said first deposition system;
holding said sheet means of said two support elements;
reciprocally approaching said two support elements for making on said sheet fold comprising at least three folding lines arranged in spatial sequence on said sheet;
commanding said two support elements for bringing two terminally opposite folding lines of said at least three folding lines into substantial mutual contact;
applying said gluing material by means of said dispensing system onto said sheet at opposite side to said two support elements;
coupling by said second deposition system said base layer to said sheet with said gluing material interposed between said base layer and said sheet, for producing said article.

12. The machine according to claim 11, wherein each of said two support elements comprises a respective support face structured for supporting said sheet.

13. The machine according to claim 11, wherein said plurality of support elements comprises two or more pairs of directly consecutive support elements including said two support elements, each pair of support elements sharing a support element with a directly consecutive pair of support elements, and wherein said control unit is programmed for commanding each pair of support elements in a similar manner as said two support elements.

14. The machine according claim 11, comprising a linear transport system comprising a fixed linear guide defining a processing path, and said plurality of support elements slidingly engaging said fixed guide, wherein said linear transport system is structured for moving each support element under sliding along said fixed guide independently from the remaining support elements, and wherein said control unit is programmed for reciprocally approaching said two support elements while keeping said two support elements under movement along said processing path.

15. The machine according to claim 14, wherein said fixed guide has a main development line with closed path.
